(19) United States
(12) Patent Application Publication
(10) Pub. No.: US 2024/0159267 A1
(43) Pub. Date: May 16, 2024

(54) FOIL BEARING, AND FOIL BEARING UNIT

(71) Applicant: KABUSHIKI KAISHA TOYOTA JIDOSHOKKI, Kariya-shi, Aichi-ken (JP)

(72) Inventors: Fumiya SHINODA, Kariya-shi (JP); Fumihiro SUZUKI, Kariya-shi (JP); Hidefumi MORI, Kariya-shi (JP)

(73) Assignee: KABUSHIKI KAISHA TOYOTA JIDOSHOKKI, Kariya-shi, Aichi-ken (JP)

(21) Appl. No.: 18/284,443

(22) PCT Filed: Mar. 18, 2022
(86) PCT No.: PCT/JP2022/012616

§ 371 Date: Sep. 27, 2023

(30) Foreign Application Priority Data
Mar. 31, 2021 (JP) 2021-061866

(51) Int. Cl. F16C 17/02

(52) U.S. Cl. CPC F16C 17/024

(57) ABSTRACT

A foil bearing includes a top foil, which includes a bearing surface facing a rotary member, extends in a circumferential direction, and includes a fixed end at one end in the circumferential direction and a free end at the other end in the circumferential direction, and a sheet-shaped back foil, which elasticity supports the top foil. The top foil includes a connecting section that connects, at a location between the fixed end and the free end, a first side of the top foil, at which the bearing surface is located, to a second side of the top foil, at which the back foil is located, and a cutout section that reduces the thickness of the top foil so as to facilitate deformation of the top foil. The cutout section is formed at the second side rather than the first side.

### TECHNICAL FIELD

The present disclosure relates to a foil bearing and a foil bearing unit.

### BACKGROUND ART

A foil bearing unit includes a foil bearing. For example, Patent Literature 1 describes a foil bearing including a top foil and a back foil. The top foil extends circumferentially and includes a bearing surface facing a rotary member. The top foil includes a fixed end at one circumferential end and a free end at the other circumferential end. The back foil is a sheet that elastically supports the top foil.

This foil bearing supports the rotary member while in contact with the rotary member until the rotary member reaches its no-contact rotation speed. When the rotation speed of the rotary member reaches the no-contact rotation speed, the rotary member is separated from the foil bearing due to the dynamic pressure of the air film created between the foil bearing and the rotary member. The foil bearing thus supports the rotary member without being in contact with the rotary member.

For example, when the rotary member is tilted with respect to the foil bearing or the rotary member is deformed, the position of the rotary member relative to the foil bearing may be displaced from the desired position. Any displacement of the rotary member from the desired position relative to the foil bearing may cause the thickness of the air film created between the rotary member and the top foil to partially become larger than the desired thickness. A section of the air film created between the rotary member and the top foil that has a larger thickness has a lower dynamic pressure of the air film for supporting the rotary member. This reduces the load capacity of the foil bearing. When the load capacity of the foil bearing is reduced, it is difficult for the foil bearing to stably support the rotary member.

Patent Literature 2 describes a radial foil bearing including a top foil with a slide layer at the surface for supporting a rotary member so as to be relatively rotatable. The slide layer consists of multiple films divided in the circumferential direction. The slide layer is made of a material different from the base material of the top foil. Patent Literature 2 describes, in addition to that the slide layer is divided into multiple regions in the circumferential direction of the top foil, that the slide layer is divided into multiple regions in the axial direction. With this configuration, even when the position of the rotary member relative to the radial foil bearing is displaced from the desired position, the elastic force of the back foil resists the dynamic pressure of the air film, allowing the top foil to be elastically deformed. This allows the top foil to easily follow the displacement of the rotary member.

### CITATION LIST

### Patent Literature

Patent Literature 1: Japanese Laid-Open Patent Publication No. 2005-9556
Patent Literature 2: Japanese Laid-Open Patent Publication No. 2019-82195

### SUMMARY OF INVENTION

### Technical Problem

In the foil bearing of Patent Literature 2, the sections in which the slide layer is not formed, that is, the sections between the separate regions face the rotary member. As such, the thickness of the air film created between the rotary member and the top foil tends to increase at the sections in which the slide layer is not formed. This may reduce the load capacity of the foil bearing. In particular, when the sections in which the slide layer is not formed extend in the axial direction and the circumferential direction, the load capacity of the foil bearing tends to decrease. As a result, it is difficult for the foil bearing to stably support the rotary member.

### Solution to Problem

In one general aspect of the present disclosure, a foil bearing that includes a top foil and a sheet-shaped back foil is provided. The top foil includes a bearing surface facing a rotary member and extends in a circumferential direction. The top foil includes a fixed end at one end in the circumferential direction and a free end at the other end in the circumferential direction. The sheet-shaped back foil elastically supports the top foil. The top foil includes a connecting section and a cutout section. The connecting section connects, at a location between the fixed end and the free end, a first side of the top foil, at which the bearing surface is located, to a second side of the top foil, at which the back foil is located. The cutout section reduces a thickness of the top foil so as to facilitate deformation of the top foil. The cutout section is formed at the second side rather than at the first side.

### BRIEF DESCRIPTION OF DRAWINGS

FIG. 1 is a schematic diagram of a turbomachine according to an embodiment.

FIG. 2 is an exploded perspective view showing a radial foil bearing.

FIG. 3 is a cross-sectional view taken along line 3-3 in FIG. 1.

FIG. 4 is a cross-sectional view showing a first top foil and its surrounding area.

FIG. 5 is a cross-sectional view showing a fixed end of the first top foil of FIG. 4 and its surrounding area.

FIG. 6 is a developed view showing a part of a second plate member in a developed state.

FIG. 7 is a cross-sectional view taken along line 7-7 in FIG. 1.

FIG. 8 is a cross-sectional view taken along line 8-8 in FIG. 7.

FIG. 9 is a cross-sectional view taken along line 9-9 in FIG. 8.

FIG. 10 is a cross-sectional view showing a part of a first top foil and its surrounding area in another embodiment.

FIG. 11 is a cross-sectional view showing the fixed end of the first top foil of FIG. 10 and its surrounding area.

FIG. 12 is a cross-sectional view showing a part of a first top foil and its surrounding area in yet another embodiment.

### DESCRIPTION OF EMBODIMENTS

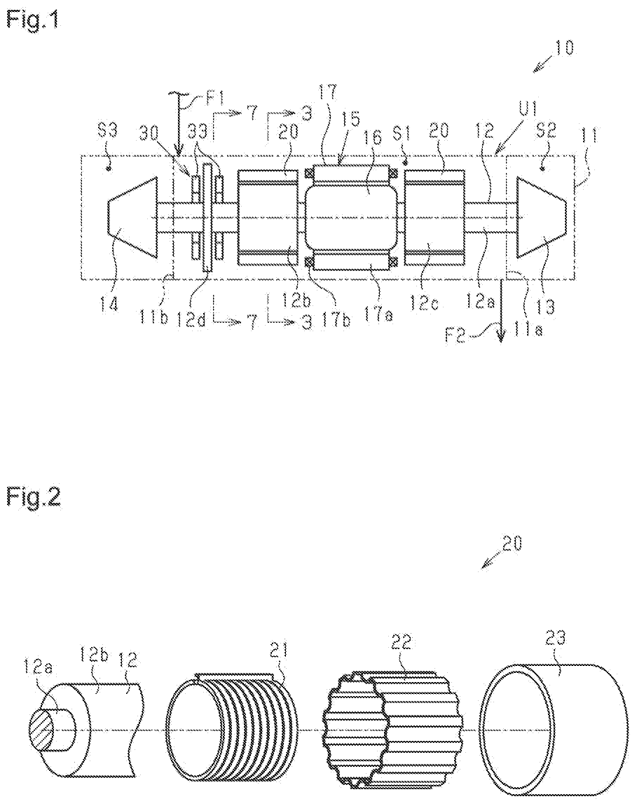

Referring to FIGS. 1 to 8, a foil bearing and a foil bearing unit including a foil bearing according to an embodiment will now be described. The foil bearing unit of this embodiment is used in a turbomachine mounted on a fuel cell electric vehicle. The fuel cell electric vehicle is equipped with a fuel cell system, which supplies oxygen and hydrogen to a fuel cell to generate electricity. The turbomachine compresses air, which is a fluid containing oxygen, to be supplied to the fuel cell.

<Overall Configuration of Turbomachine 10>

As shown in FIG. 1, a turbomachine 10 includes a foil bearing unit U1. The foil bearing unit U1 includes a tubular housing 11 and three foil bearings, namely two radial foil bearings 20 and one thrust foil bearing 30.

The turbomachine 10 includes a rotary member 12 housed within the housing 11. The housing 11 supports the rotary member 12 in a rotatable manner. The axial direction of the housing 11 agrees with the axial direction of the rotary member 12. The housing 11 includes a motor chamber S1, a turbine chamber S2, and an impeller chamber S3. The foil bearing unit U1 thus includes the motor chamber S1. The motor chamber S1, the turbine chamber S2, and the impeller chamber S3 are arranged side by side in the axial direction of the rotary member 12 in the order of the turbine chamber S2, the motor chamber S1, and the impeller chamber S3.

The housing 11 includes a first partition wall 11a and a second partition wall 11b. The first partition wall 11a divides the interior of the housing 11 into the motor chamber S1 and the turbine chamber S2. The second partition wall 11b divides the interior of the housing 11 into the motor chamber S1 and the impeller chamber S3. The motor chamber S1 houses an electric motor 15. The turbine chamber S2 houses a turbine wheel 13. The impeller chamber S3 houses a compressor impeller 14.

The rotary member 12 includes a rotating shaft 12a, a first support portion 12b, a second support portion 12c, and a third support portion 12d. The rotating shaft 12a is columnar. The rotating shaft 12a is provided so as to extend through the turbine chamber S2, the motor chamber S1, and the impeller chamber S3. The turbine wheel 13 is attached to one end of the rotating shaft 12a. The compressor impeller 14 is attached to the other end of the rotating shaft 12a.

The electric motor 15 includes a rotor 16 and a stator 17. The rotor 16 is placed inside the stator 17. The rotor 16 rotates synchronously with the rotary member 12. The stator 17 is fixed to the housing 11. The stator 17 includes a tubular stator core 17a and coils 17b. The stator core 17a is fixed to the housing 11. The coils 17b are wound around the stator core 17a. A current from a battery (not shown) flows through the coils 17b, thereby rotating the rotor 16 synchronously with the rotary member 12. This rotates the turbine wheel 13 and the compressor impeller 14 integrally with the rotary member 12.

The first support portion 12b is located in the motor chamber S1. The first support portion 12b is columnar and has a larger outer diameter than the rotating shaft 12a. The first support portion 12b is located between the electric motor 15 and the compressor impeller 14 in the axial direction of the rotating shaft 12a. The radial direction of the first support portion 12b agrees with the radial direction of the rotating shaft 12a. The axis of the first support portion 12b agrees with the axis of the rotating shaft 12a.

The second support portion 12c is located in the motor chamber S1. The second support portion 12c is columnar and has a larger outer diameter than the rotating shaft 12a. The second support portion 12c is located between the electric motor 15 and the turbine wheel 13 in the axial direction of the rotating shaft 12a. The radial direction of the second support portion 12c agrees with the radial direction of the rotating shaft 12a. The axis of the second support portion 12c agrees with the axis of the rotating shaft 12a.

The third support portion 12d is located in the motor chamber S1. The third support portion 12d is disc-shaped and extends from the outer circumferential surface of the rotating shaft 12a in the radial direction of the rotating shaft 12a. The third support portion 12d is located between the first support portion 12b and the compressor impeller 14 in the axial direction of the rotating shaft 12a. The radial direction of the third support portion 12d agrees with the radial direction of the rotating shaft 12a. The axis of the third support portion 12d agrees with the axis of the rotating shaft 12a.

The radial foil bearings 20 rotationally support the rotary member 12 in the radial direction. The “radial direction” of the rotary member 12 is a direction perpendicular to the axial direction of the rotary member 12. The axial direction of the rotary member 12 may also be referred to as a “thrust direction”. The radial direction of the rotating shaft 12a agrees with a direction perpendicular to the axial direction of the rotary member 12. As such, the radial direction of the rotary member 12 agrees with the radial direction of the rotating shaft 12a.

Upstream cooling piping F1 and downstream cooling piping F2 are connected to the motor chamber S1. The upstream cooling piping F1 is connected to a section of the motor chamber S1 near the impeller chamber S3. The downstream cooling piping F2 is connected to a section of the motor chamber S1 near the turbine chamber S2. A coolant is conducted into the motor chamber S1 from the upstream cooling piping F1. The coolant conducted into the motor chamber S1 flows through the motor chamber S1 and is discharged through the downstream cooling piping F2. The coolant cools the radial foil bearings 20 and the thrust foil bearing 30 while passing through the motor chamber S1.

<Configuration of Radial Foil Bearing 20>

As shown in FIG. 2, each radial foil bearing 20 includes a first top foil 21, which is a top foil, a sheet-shaped first back foil 22, which is a back foil, and a bearing housing 23. The bearing housing 23 is cylindrical. The bearing housing 23 is made of metal, for example. The first top foil 21 is placed inside the bearing housing 23.

<Configuration of First Top Foil 21>

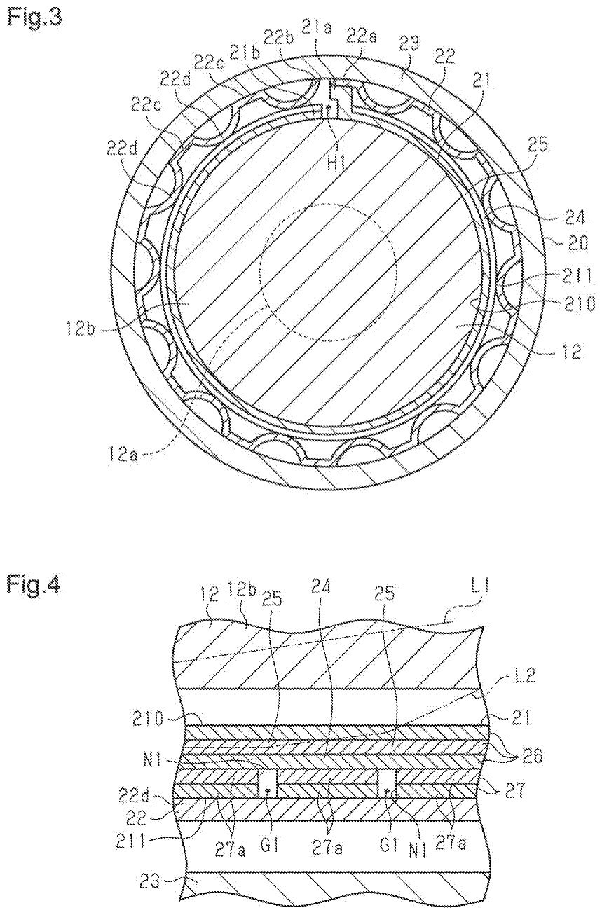

As shown in FIGS. 2 and 3, the first top foil 21 is substantially cylindrical. For example, the first top foil 21 may be formed by curving a strip-shaped flexible metal plate into a cylindrical shape.

As shown in FIG. 3, the first top foil 21 extends in the circumferential direction and includes a bearing surface 210 facing the first support portion 12b. The bearing surface 210 faces the first support portion 12b in the radial direction. The first top foil 21 includes a fixed end 21a at one circumferential end and a free end 21b at the other circumferential end. The fixed end 21a is formed by bending one circumferential end of the first top foil 21 outward in the radial direction of the first top foil 21. The free end 21b faces and is spaced apart from the fixed end 21a in the circumferential direction of the first top foil 21. As such, the first top foil 21 includes a first connecting section H1, which is a connecting section connecting a first side of the first top foil 21, at which the bearing surface 210 is located, to a second side of the first top foil 21, at which the first back foil 22 is located at a location between the fixed end 21a and the free end 21b. The first connecting section H1 is a gap provided between the fixed end 21a and the free end 21b. The first top foil 21 is a non-annular member, in which a part in the circumferential direction is cut out.

As shown in FIG. 4, the first top foil 21 is formed by stacking multiple first plate members 26 and multiple second plate members 27. Each of the first and second plate members 26 and 27 is cylindrical. The second plate members 27 are positioned outward of the first plate members 26 in the radial direction of the first top foil 21. The second plate members 27 thus cover the first plate members 26. Each first plate member 26 is made of a flexible metal material, for example. In this embodiment, each first plate member 26 is made of Inconel. Each second plate member 27 is made of a flexible metal material, for example. In this embodiment, each second plate member 27 is made of Inconel. The axial dimension of the second plate member 27 is equal to the axial dimension of the first plate member 26.

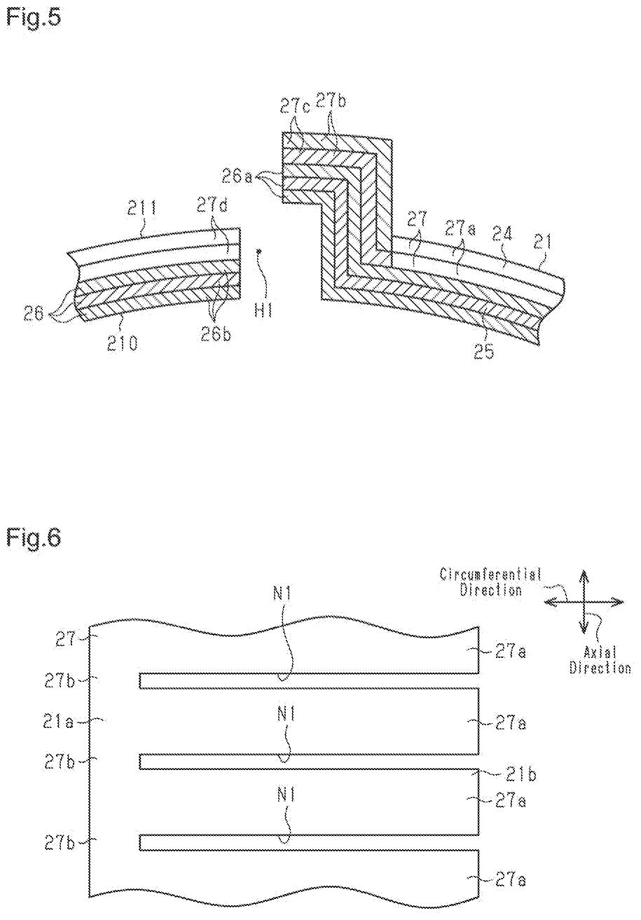

As shown in FIGS. 3 and 5, each first plate member 26 includes a first fixed end 26a at one circumferential end and a first free end 26b at the other circumferential end. Of the multiple first plate members 26, the innermost first plate member 26 in the radial direction of the first top foil 21 has an inner circumferential surface forming the bearing surface 210. Each second plate member 27 includes a second fixed end 27c at one circumferential end and a second free end 27d at the other circumferential end. The fixed end 21a of the first top foil 21 is formed by the first fixed ends 26a and the second fixed ends 27c placed over one another. The free end 21b of the first top foil 21 is formed by the first free ends 26b and the second free ends 27d placed over one another.

As shown in FIG. 6, each second plate member 27 includes multiple cutout sections N1. The cutout sections N1 extend from one circumferential edge of the second plate member 27 toward the other circumferential edge. In the circumferential direction of the second plate member 27, the cutout sections N1 of the second plate member 27 have the same length. The cutout sections N1 are arranged at regular intervals in the axial direction of the second plate member 27. Since the cutout sections N1 are formed, the second plate member 27 includes multiple main sections 27a, which are arranged side by side in the axial direction of the second plate member 27 and extend in the circumferential direction of the second plate member 27, and connection sections 27b, which connect adjacent main sections 27a in the axial direction of the second plate member 27. Each connection section 27b is adjacent to the corresponding cutout section N1 in the circumferential direction of the second plate member 27.

As shown in FIG. 4, the second plate members 27 are arranged such that the cutout sections N1 are aligned with one another in the radial direction of the first top foil 21. First gaps G1 extending around the axis of the rotary member 12 are formed by the respective cutout sections N1 aligned in the radial direction of the first top foil 21. Each cutout section N1 opens to the outer circumferential surface 211 of the first top foil 21. Also, each cutout section N1 does not open to the bearing surface 210 of the first top foil 21. As such, each cutout section N1 is formed at the second side, at which the first back foil 22 is located, rather than at the first side, at which the bearing surface 210 is located.

In the first top foil 21, sections that are aligned with the first gaps G1 in the radial direction are first thin sections 25. As such, the first thin sections 25 extend along the respective first gaps G1 and extend in the circumferential direction of the first top foil 21. The first thin sections 25 are arranged at regular intervals in the axial direction of the first top foil 21.

The section of the first top foil 21 other than the first thin sections 25 is a first thick section 24. Specifically, as shown in FIGS. 4, 5, and 6, the first thick section 24 is the section in which the first plate members 26 and the main sections 27a or the connection sections 27b of the second plate members 27 are placed over one another. Thus, each first thin section 25 is a section of the first top foil 21 having a thickness that is less than the thickness of the first thick section 24 by the first gap G1. Accordingly, the first thick section 24 and the first thin sections 25 are formed by stacking the multiple first plate members 26 and the second plate members 27 including the cutout sections N1 forming the first gaps G1.

The section of the first thick section 24 excluding the section formed by the main sections 27a and the sections of the first plate members 26 placed over the main sections 27a forms the fixed end 21a of the first top foil 21. The section of the first thick section 24 excluding the section forming the fixed end 21a extends in the circumferential direction of the first top foil 21 along the first thin sections 25. The sections of the first thick section 24 excluding the sections forming the fixed end 21a and the first thin section 25 are arranged side by side in the thrust direction. As such, the first thick section 24 and the first thin sections 25 are at least partially arranged side by side in the thrust direction. The first gaps G1 extend around the axis of the rotary member 12 without opening to the bearing surface 210 so as to form the first thick section 24 and the first thin sections 25. The multiple cutout sections N1 are formed to extend in the circumferential direction of the first top foil 21 and be arranged side by side only in the axial direction of the rotary member 12 with respect to the axial direction of the rotary member 12.

<Configuration of First Back Foil 22>

As shown in FIG. 3, the first back foil 22 is substantially cylindrical. The first back foil 22 is made of a flexible metal material, for example. In this embodiment, the first back foil 22 is formed by shaping a strip-shaped plate made of Inconel into a corrugated shape and then curving it into a tubular shape.

The first back foil 22 includes a fixed end 22a and a free end 22b. The fixed end 22a is fixed to the bearing housing 23. The fixed end 22a is fixed to the bearing housing 23 by welding with the fixed end 22a aligned with the fixed end 21a of the first top foil 21 in the radial direction of the rotating shaft 12a. The fixed end 21a of the first top foil 21 is fixed to the fixed end 22a of the first back foil 22 by welding. Thus, the fixed end 21a of the first top foil 21 is fixed to the bearing housing 23 through the fixed end 22a of the first back foil 22. The free end 22b faces and is spaced apart from the fixed end 22a in the circumferential direction of the first back foil 22. The first back foil 22 is a non-annular member, in which a part in the circumferential direction is cut out.

The first back foil 22 is placed between the inner circumferential surface of the bearing housing 23 and the first top foil 21. The first back foil 22 is placed radially outward of the first top foil 21. The first back foil 22 elastically supports the first top foil 21.

The first back foil 22 includes multiple valleys 22c and multiple peaks 22d. Each valley 22c extends along the inner circumferential surface of the bearing housing 23 while in contact with the inner circumferential surface of the bearing housing 23. Each peak 22d protrudes in a direction away from the inner circumferential surface of the bearing housing 23 and is curved in an arc so as to bulge toward the outer circumferential surface of the first top foil 21. The valleys 22c and the peaks 22d are alternately arranged in the circumferential direction of the first back foil 22. The circumferential direction of the first back foil 22 agrees with the circumferential direction of the bearing housing 23. As such, the valleys 22c and the peaks 22d are alternately arranged in the circumferential direction of the bearing housing 23 from the fixed end 22a toward the free end 22b.

When the rotary member 12 is not rotating, the valleys 22c of the first back foil 22 are in contact with the inner circumferential surface of the bearing housing 23, and the peaks 22d of the first back foil 22 are in contact with the outer circumferential surface of the first thick section 24 of the first top foil 21. When the rotary member 12 rotates, the first top foil 21 is elastically deformed radially outward. As a result, air enters between the rotary member 12 and the bearing surface 210 of the first top foil 21 to form an air film. Then, the rotary member 12 is separated from the first top foil 21 due to the dynamic pressure of the air film.

The air film between the rotary member 12 and the bearing surface 210 of the first top foil 21 elastically deforms the first top foil 21 radially outward. Thus, the first top foil 21 presses the peaks 22d of the first back foil 22, which are in contact with the outer circumferential surface of the first top foil 21, radially outward. As a result, the first back foil 22 is elastically deformed radially outward together with the first top foil 21. The first back foil 22 elastically supports the first top foil 21 in this manner.

<Configuration of Thrust Foil Bearing 30>

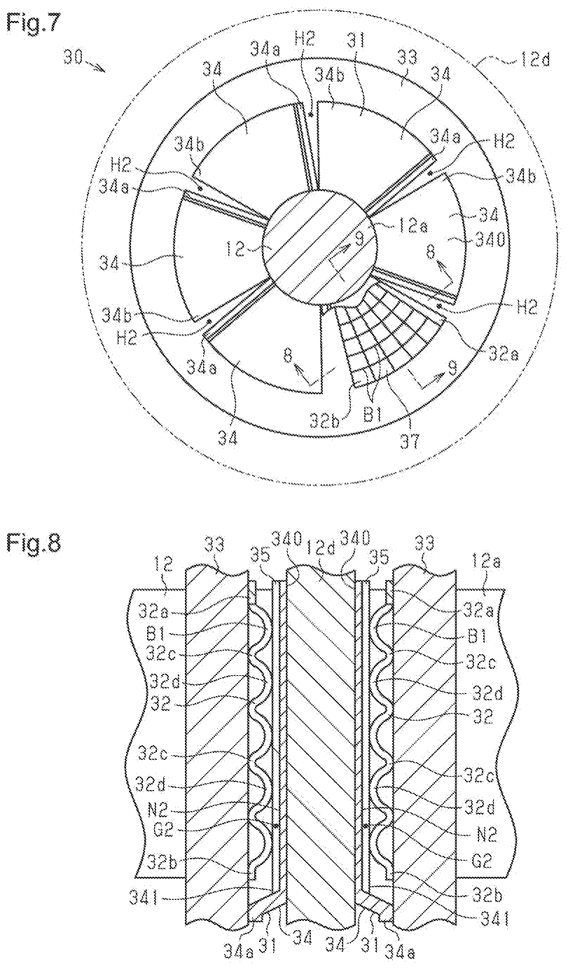

As shown in FIGS. 7, 8, and 9, the thrust foil bearing 30 includes two second top foils 31, which are top foils, two second back foils 32, which are back foils, and two base portions 33. Each base portion 33 is disc-shaped. The base portions 33 are arranged so as to sandwich the third support portion 12d in the thrust direction. The circumferential direction of the base portion 33 agrees with the circumferential direction of the rotating shaft 12a.

<Configuration of Second Top Foil 31>

As shown in FIG. 7, each second top foil 31 includes multiple top foil segments 34. Each top foil segment 34 is sectorial in plan view. Each top foil segment 34 is made of a flexible metal material, for example. In this embodiment, each top foil segment 34 is made of Inconel. The top foil segments 34 are arranged around the rotating shaft 12a. The top foil segments 34 are arranged at regular intervals in the circumferential direction of the rotating shaft 12a.

As shown in FIGS. 7 and 8, each top foil segment 34 extends in the circumferential direction and includes a bearing surface 340 facing the third support portion 12d. The bearing surface 340 faces the third support portion 12d in the axial direction. Each top foil segment 34 includes a fixed end 34a at one circumferential end and a free end 34b at the other circumferential end. The fixed end 34a extends in the radial direction of the rotating shaft 12a. The fixed end 34a is formed by bending one circumferential end of the top foil segment 34 toward the base portion 33. The fixed end 34a is fixed to the base portion 33 by welding. The free end 34b is not fixed to the base portion 33. The fixed end 34a of a top foil segment 34 and the free end 34b of the adjacent top foil segment 34 are spaced apart from each other in the circumferential direction. As such, the second top foil 31 includes second connecting sections H2, which are connecting sections that connect, at locations between the fixed ends 34a and the free ends 34b, the first side of the second top foil 31, at which the bearing surface 340 is located, to the second side of the second top foil 31, at which the second back foil 32 is located. The second connecting sections H2 are gaps provided between the fixed ends 34a and the free ends 34b.

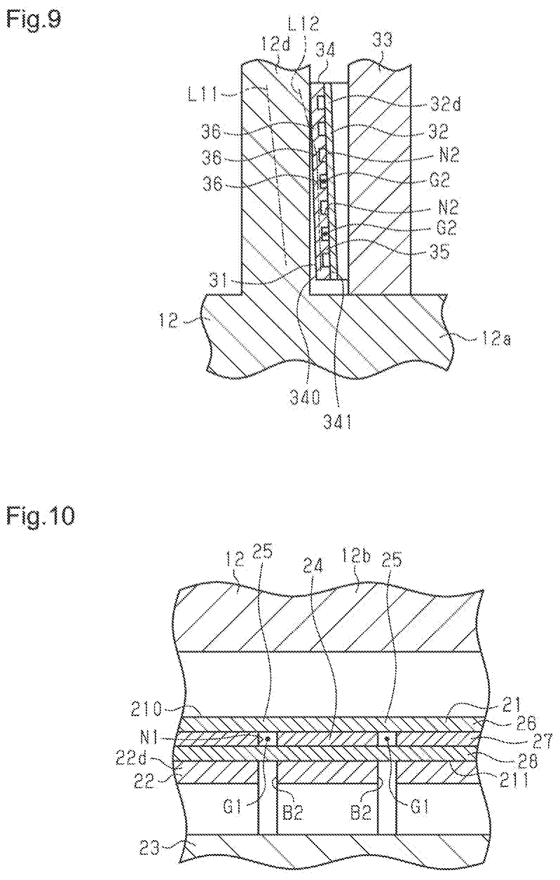

As shown in FIGS. 8 and 9, each top foil segment 34 includes multiple cutout sections N2. The cutout sections N2 are formed in a supported surface 341, which is the surface at one of the sides in the thickness direction of the top foil segment 34. The cutout sections N2 extend in the circumferential direction from the free end 34b toward the fixed end 34a of each top foil segment 34. The cutout sections N2 extend in the circumferential direction of each top foil segment 34, leaving the fixed end 34a intact. The cutout sections N2 of each top foil segment 34 are arranged at regular intervals in the radial direction of the top foil segment 34. Each top foil segment 34 is fixed to the base portion 33 with the supported surface 341 including the cutout section N2 facing toward the base portion 33 in the thrust direction. Each cutout section N2 forms a second gap G2 extending around the axis of the rotary member 12. Each second gap G2 opens to the supported surface 341 of the top foil segment 34. Also, each cutout section N2 does not open to the bearing surface 340 of the second top foil 31. As such, each cutout section N2 is formed at the second side, at which the second back foil 32 is located, rather than at the first side, at which the bearing surface 340 is located.

Sections of each top foil segment 34 that are aligned with the second gaps G2 in the thickness direction of the top foil segment 34 are second thin sections 36. As such, the second thin sections 36 extend along the respective second gaps G2 and extend in the circumferential direction of the top foil segment 34. The second thin sections 36 are arranged at regular intervals in the radial direction of each top foil segment 34.

The section of each top foil segment 34 other than the second thin sections 36 is a second thick section 35, which is a thick section. Thus, the second thin section 36 is a section of the top foil segment 34 having a thickness that is less than the thickness of the second thick section 35 by the second gap G2. The fixed end 34a of each top foil segment 34 is a part of the second thick section 35. The section of the second thick section 35 excluding the section forming the fixed end 34a extends in the circumferential direction of the top foil segment 34 along the second thin sections 36. The section of the second thick section 35 excluding the section forming the fixed end 34a and the second thin sections 36 are arranged side by side in the radial direction. As such, the second thick section 35 and the second thin sections 36 are at least partially arranged side by side in the radial direction. The second gaps G2 extend around the axis of the rotary member 12 without opening to the bearing surface 340 so as to form the second thick section 35 and the second thin sections 36. The multiple cutout sections N2 are formed to extend in the circumferential direction of the top foil segment 34 and be arranged side by side only in the radial direction of the top foil segment 34 with respect to the axial direction of the rotary member 12.

<Configuration of Second Back Foil 32>

As shown in FIG. 7, the second back foil 32 includes multiple back foil segments 37. Each back foil segment 37 is substantially sectorial in plan view. Each back foil segment 37 is made of a flexible metal material, for example. In this embodiment, each back foil segment 37 is formed by corrugating an Inconel plate.

Each back foil segment 37 includes a fixed end 32a and a free end 32b. The fixed end 32a is fixed to the base portion 33. The fixed end 32a is one of multiple valleys 32c that is located at one circumferential end of the back foil segment 37. The free end 32b is one of multiple valleys 32c that is located at the other circumferential end of the back foil segment 37. The free end 32b is not fixed to the base portion 33.

As shown in FIG. 8, each back foil segment 37 includes multiple valleys 32c and multiple peaks 32d. The valleys 32c extend in the radial direction of the back foil segment 37. Each peak 32d protrudes in a direction away from the base portion 33 and is curved in an arc so as to bulge toward the top foil segment 34. The valleys 32c and the peaks 32d alternate in the circumferential direction of the back foil segment 37, so that the back foil segment 37 is corrugated. The circumferential direction of each back foil segment 37 agrees with the circumferential direction of the base portion 33. As such, the valleys 32c and the peaks 32d are alternately arranged in the circumferential direction of the third support portion 12d from the fixed end 32a toward the free end 32b.

As shown in FIGS. 7 and 8, each back foil segment 37 includes multiple slits B1. The slits B1 extend through the back foil segment 37 in the thickness direction. Each slit B1 extends across the valleys 32c and the peaks 32d in the circumferential direction of the back foil segment 37. Each slit B1 extends in the circumferential direction from the free end 32b toward the fixed end 32a of the back foil segment 37. The slits B1 extend in the circumferential direction of the back foil segment 37, leaving the fixed end 32a intact. The slits B1 of each back foil segment 37 are arranged at regular intervals in the radial direction of each back foil segment 37.

The back foil segments 37 are positioned between the base portion 33 and the respective top foil segments 34. Each back foil segment 37 elastically supports the corresponding top foil segment 34. As such, the second back foil 32 elastically supports the corresponding second top foil 31. Each top foil segment 34 and the corresponding back foil segment 37 are arranged such that the second gaps G2 are aligned with the slits B1. Each top foil segment 34 is thus positioned relative to the corresponding back foil segment 37 such that the second gaps G2 extend along the slits B1.

When the rotary member 12 is not rotating, the valleys 32c of the back foil segments 37 are in contact with the base portion 33, and the peaks 32d of the back foil segments 37 are in contact with the second thick section 35 of the corresponding top foil segments 34. Then, when the rotary member 12 rotates, each top foil segment 34 is elastically deformed toward the corresponding back foil segment 37. This allows air to enter between the rotary member 12 and the bearing surfaces 340 of the top foil segments 34, forming an air film. Then, the rotary member 12 is separated from the top foil segments 34 due to the dynamic pressure of the air film.

The air film between the third support portion 12d and the bearing surface 340 of each top foil segment 34 elastically deforms the top foil segments 34 toward the corresponding second back foil 32. Then, each top foil segment 34 presses the peaks 32d of the corresponding back foil segment 37 toward the base portion 33. Accordingly, each back foil segment 37 is elastically deformed toward the base portion 33 together with the corresponding top foil segment 34. As such, each back foil segment 37 elastically supports the corresponding top foil segment 34.

<Operation>

Operation of the present embodiment is now described.

For example, when the rotary member 12 is tilted with respect to the radial foil bearings 20 or the rotary member 12 is deformed, the position of the rotating shaft 12a relative to each radial foil bearing 20 may be displaced from the desired position. Specifically, the first support portion 12b of the rotary member 12 may be tilted with respect to the axis of the first top foil 21 as indicated by imaginary line L1 in FIG. 4, for example. In the radial foil bearing 20, the cutout sections N1 are arranged side by side only in the axial direction of the rotary member 12 with respect to the axial direction of the rotary member 12, and the first thick section 24 and the first thin sections 25 are at least partially arranged side by side in the thrust direction. Accordingly, the axial rigidity of the first top foil 21 is lower than the circumferential rigidity of the first top foil 21. As a result, the elastic force of the first back foil 22 resists the dynamic pressure of the air film, allowing the first top foil 21 to be elastically deformed with the first thin sections 25 serving as starting points as indicated by imaginary line L2 in FIG. 4. That is, the first top foil 21 is allowed to be elastically deformed with the cutout sections N1 serving as starting points. The first top foil 21 includes the cutout sections N1, which reduce the thickness of the first top foil 21 so as to facilitate deformation of the first top foil 21. This allows the first top foil 21 to easily follow the tilting of the first support portion 12b.

The cutout sections N1 extend in the circumferential direction, and the first thick section 24 extends in the circumferential direction. The first top foil 21 thus has a high rigidity in the circumferential direction. Accordingly, the first top foil 21 is less likely to be deformed and pressed toward the first back foil 22. Also, the cutout sections N1 are formed at the second side, at which the first back foil 22 is located, rather than at the first side, at which the bearing surface 210 is located. Thus, the cutout sections N1 do not open to the bearing surface 210. As a result, when the rotary member 12 levitates with respect to the radial foil bearing 20, the thickness of the air film created between the rotary member 12 and the first top foil 21 is less likely to increase.

Furthermore, when the rotary member 12 is tilted with respect to the thrust foil bearing 30 or the rotary member 12 is deformed, the position of the third support portion 12d relative to the thrust foil bearing 30 may be displaced from the desired position, for example. Specifically, the third support portion 12d may be tilted with respect to the radial direction of the rotating shaft 12a as indicated by imaginary line L11 in FIG. 9, for example. In the thrust foil bearing 30, multiple cutout sections N2 are arranged side by side only in the radial direction of each top foil segment 34 with respect to the axial direction of the rotary member 12, and the second thick section 35 and the second thin sections 36 are at least partially arranged side by side in the radial direction. Accordingly, the radial rigidity of the second top foil 31 is lower than the circumferential rigidity of the second top foil 31. As a result, the elastic force of the second back foil 32 resists the dynamic pressure of the air film, allowing the top foil segments 34 to be elastically deformed with the second thin sections 36 serving as starting points as indicated by imaginary line L12 in FIG. 9. That is, each top foil segment 34 is allowed to be elastically deformed with the cutout sections N2 serving as starting points. The top foil segment 34 includes the cutout sections N2, which reduce the thickness of the top foil segment 34 so as to facilitate deformation of the top foil segment 34. This allows the top foil segment 34 to easily follow the tilting of the third support portion 12d with respect to the top foil segment 34.

The cutout sections N2 extend in the circumferential direction, and the second thick section 35 extends in the circumferential direction. The top foil segment 34 thus has a high rigidity in the circumferential direction of the rotating shaft 12a. Thus, the top foil segment 34 is less likely to be deformed and pressed toward the second back foil 32. Also, the cutout sections N2 are formed at the second side, at which the second back foil 32 is located, rather than at the first side, at which the bearing surface 340 is located. Thus, the cutout sections N2 do not open to the bearing surface 340. As a result, when the third support portion 12d is separated from the thrust foil bearing 30, the thickness of the air film created between the third support portion 12d and the top foil segments 34 is less likely to increase. The above embodiment has the following advantages.

(1) The cutout sections N1 are formed at the second side, at which the first back foil 22 is located, rather than at the first side, at which the bearing surface 210 is located. This allows the bearing surface 210 to be smooth as compared with a configuration in which the cutout sections N1 are formed at the first side, for example. This avoids a problem with conventional art where the thickness of the air film created between the first support portion 12b and the first top foil 21 increases at each cutout section N1. This limits a decrease in the load capacity of the radial foil bearing 20, allowing the radial foil bearing 20 to stably support the rotary member 12.

Also, the cutout sections N2 are formed at the second side, at which the second back foil 32 is located, rather than at the first side, at which the bearing surface 340 is located. This allows the bearing surface 340 to be smooth as compared with a configuration in which the cutout sections N2 are formed at the first side, for example. This avoids a problem with conventional art where the thickness of the air film created between the third support portion 12d and the top foil segment 34 increases at each cutout section N2. This limits a decrease in the load capacity of the thrust foil bearing 30, allowing the thrust foil bearing 30 to stably support the rotary member 12.

(2) The first top foil 21 is formed by stacking the first plate members 26 and the second plate members 27 including the cutout sections N1. This configuration is desirable as the configuration of the first top foil 21 that includes the cutout sections N1, which reduce the thickness of the first top foil 21 so as to facilitate deformation of the first top foil 21.

(3) The multiple cutout sections N1 are formed to extend in the circumferential direction of the first top foil 21 and be arranged side by side only in the axial direction of the rotary member 12 with respect to the axial direction of the rotary member 12. Accordingly, the rigidity of the first top foil 21 in the axial direction of the rotary member 12 is lower than the circumferential rigidity of the first top foil 21. As such, even when the position of the rotary member 12 relative to the radial foil bearing 20 is displaced from the desired position, the elastic force of the first back foil 22 resists the dynamic pressure of the air film, allowing the first top foil 21 to be elastically deformed with the cutout sections N1 serving as starting points. This allows the first top foil 21 to easily follow the displacement of the rotary member 12. Also, the cutout sections N1 extend in the circumferential direction, providing the high circumferential rigidity of the first top foil 21. This reduces the likelihood of the first top foil 21 being deformed and entirely pressed onto the first back foil 22.

(4) The multiple cutout sections N2 are formed to extend in the circumferential direction of the top foil segment 34 and be arranged side by side only in the radial direction of the top foil segment 34 with respect to the axial direction of the rotary member 12. Accordingly, the radial rigidity of the second top foil 31 is lower than the circumferential rigidity of the second top foil 31. As such, even when the position of the rotary member 12 relative to the thrust foil bearing 30 is displaced from the desired position, the elastic force of the second back foil 32 resists the dynamic pressure of the air film, allowing the top foil segments 34 to be elastically deformed with the cutout sections N2 serving as starting points. This allows the top foil segments 34 to easily follow the displacement of the rotary member 12. Also, the cutout sections N2 extend in the circumferential direction, providing the high circumferential rigidity of the top foil segments 34. This reduces the likelihood of each first top foil 34 being deformed and entirely pressed onto the second back foil 32.

(5) Each top foil segment 34 is positioned relative to the corresponding back foil segment 37 such that the cutout sections N2 extend along the slits B1. Accordingly, when the elastic deformation of the top foil segments 34 with the cutout sections N2 serving as starting points is allowed, the elastic force of the back foil segments 37 is easily transmitted to the top foil segments 34. This allows the top foil segments 34 to easily follow the displacement of the rotary member 12.

(6) The first top foil 21 includes the cutout sections N1, and the top foil segments 34 include the cutout sections N2. This increases the surface area of the first top foil 21 and the surface area of each top foil segment 34. As a result, the efficiency of cooling of the radial foil bearing 20 and the thrust foil bearing 30 by the coolant conducted into the motor chamber S1 is improved.

<Modifications>

The embodiment described above may be modified as follows. The above embodiment and the following modifications may be combined to the extent that does not cause technical contradiction.

As shown in FIG. 10, the first back foil 22 may have multiple slits B2. The slits B2 extend through the first back foil 22 in its thickness direction. Each slit B2 extends across the valleys 22c and the peaks 22d in the circumferential direction of the first back foil 22. Each slit B2 extends in the circumferential direction from the free end 22b toward the fixed end 22a of the first back foil 22. Each slit B2 extends in the circumferential direction of the first back foil 22, leaving the fixed end 22a intact. The slits B2 are arranged at regular intervals in the axial direction of the first back foil 22. The first top foil 21 and the first back foil 22 are arranged such that the cutout sections N1 are aligned with the slits B2. Thus, the first top foil 21 is positioned relative to the first back foil 22 such that the cutout sections N1 extend along the respective slits B2.

Accordingly, when the elastic deformation of the first top foil 21 with the cutout sections N1 serving as starting points is allowed, the elastic force of the first back foil 22 is easily transmitted to the first top foil 21. This allows the first top foil 21 to easily follow the displacement of the rotary member 12.

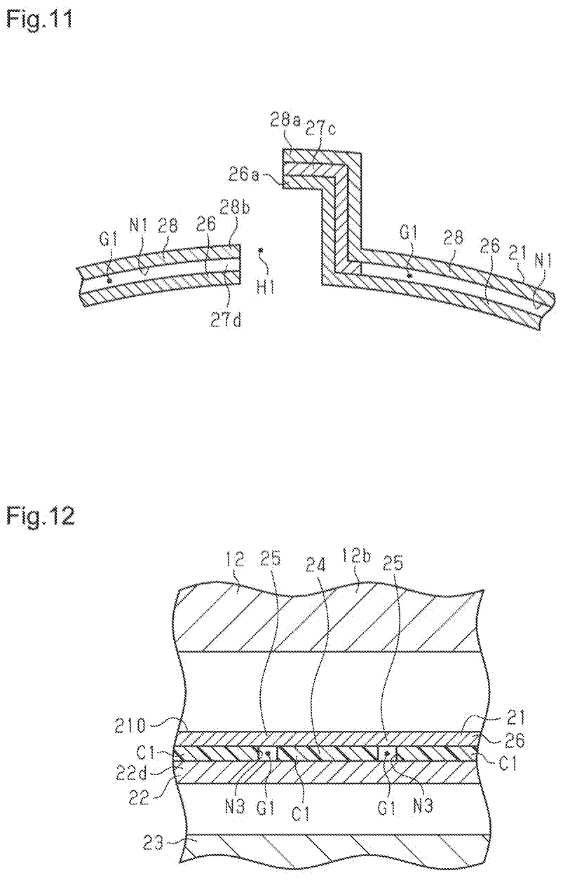

As shown in FIGS. 10 and 11, the first top foil 21 may have a third plate member 28. The third plate member 28 includes a third fixed end 28a at one circumferential end of the first top foil 21 and a third free end 28b at the other circumferential end. The third fixed end 28a, the first fixed end 26a, and the second fixed end 27c are placed over one another in the radial direction of the rotary member 12. The third free end 28b, the first free end 26b, and the second free end 27d are placed over one another in the radial direction of the rotary member 12. The third plate member 28 covers the cutout sections N1.

The third plate member 28 covering the cutout sections N1 avoids a situation where parts of the first back foil 22 are caught in the cutout sections N1. This avoids a situation where the cutout sections N1 limit movement of the first back foil 22.

In the embodiment, the cutout sections N2 may extend inside the respective top foil segments 34 around the axis of the rotary member 12 so as not to open to the supported surfaces 341 of the top foil segments 34.

As shown in FIG. 12, the first top foil 21 may be formed by a first plate member 26 and a coating layer Cl, for example. The coating layer Cl may be formed by applying a resin coating material, DLC, or metal plating to the surface of the first plate member 26 facing the first back foil 22, for example. The coating layer Cl includes multiple cutout sections N3 forming first gaps G1. In this manner, the first top foil 21 may have cutout sections N3, which reduce the thickness of the first top foil 21 so as to facilitate deformation of the first top foil 21.

In the embodiment, the supported surface 341 of each top foil segment 34 may have a coating layer, and the coating layer includes cutout sections that form second gaps G2. In this manner, each top foil segment 34 may have cutout sections that reduce the thickness of the top foil segment 34 so as to facilitate deformation of the top foil segment 34.

In the embodiment, the axial dimension of the second plate members 27 does not have to be equal to the axial dimension of the first plate members 26.

In the embodiment, the cutout sections N1 do not have to be formed in the second plate members 27 at regular intervals in the axial direction of the second plate members 27. That is, the first thin sections 25 do not have to be arranged at regular intervals in the axial direction of the first top foil 21.

In the embodiment, the cutout sections N2 do not have to be formed in the top foil segments 34 at regular intervals in the radial direction of the top foil segments 34. That is, the second thin sections 36 do not have to be arranged at regular intervals in the radial direction of the top foil segments 34.

In the embodiment, the slits B1 do not have to be formed in the back foil segments 37 at regular intervals in the radial direction of the back foil segments 37.

In the embodiment, the inner circumferential surface of the bearing housing 23 may have a recess extending in the axial direction of the rotary member 12. The fixed ends 21a and 22a may be fitted into this recess so as to be fixed to the bearing housing 23.

In the embodiment, the first and second plate members 26 and 27 do not have to be made of a flexible metal material, and may be made of plastic.

In the embodiment, there is no limitation on the number of cutout sections N1 formed in each second plate member 27.

In the embodiment, there is no limitation on the number of cutout sections N2 formed in each top foil segment 34.

The turbomachine 10 of the embodiment includes the turbine wheel 13 and the compressor impeller 14. However, it may be configured with one of the turbine wheel 13 and the compressor impeller 14 omitted.

In the embodiment, the first back foil 22 does not have to be substantially cylindrical, and may have the shape of a plate curved in an arc. Also, multiple first back foils 22 having the shape of a plate curved in an arc may be arranged side by side in the circumferential direction of the bearing housing 23 along the inner circumferential surface of the bearing housing 23.

In the embodiment, the second back foil 32 does not have to include multiple back foil segments 37 and may be annular.

In the embodiment, there is no limitation on the specific configuration of the first back foil 22, as long as the configuration allows the first back foil 22 to elastically support the first top foil 21.

In the embodiment, there is no limitation on the specific configuration of the second back foil 32, as long as the configuration allows the second back foil 32 to elastically support the second top foil 31.

In the embodiment, the first top foil 21 may be provided by forming multiple cutout sections N1 in one plate member, for example.

In the embodiment, the top foil segments 34 may be formed by stacking one plate member and a plate member including preformed cutout sections N2.

In the embodiment, the second plate member 27 includes the multiple main sections 27a and the multiple connection sections 27b, but there is no limitation to this. For example, in the step of forming cutout sections N1 in one plate member, the main sections 27a may be separated from one another so that the connection sections 27b are not formed. Then, the separated main sections 27a may be placed on the first plate member 26 at predetermined positions to form the first top foil 21. In this configuration, the first thick sections 24 and the first thin sections 25 are entirely arranged side by side in the thrust direction. In the embodiment, the first plate members 26 and the second plate members 27 forming the first top foil 21 are plate members made of flexible metal members such as Inconel, but there is no limitation to this. The first and second plate members 26 and 27 may be made of stainless steel, for example.

In the embodiment, the first back foil 22 and the second back foil 32 are made of a flexible metal material such as Inconel plate members, but there is no limitation to this. The first back foil 22 and the second back foil 32 may be made of stainless steel, for example.

In the embodiment, the top foil segments 34 forming the second top foil 31 are made of a flexible metal material such as an Inconel plate member, but there is no limitation to this. The top foil segments 34 may be made of stainless steel, for example.

In the embodiment, the turbomachine 10 compresses the air that is to be supplied to the fuel cell, but the turbomachine 10 is not limited to this and may be applied to any object. For example, the turbomachine 10 may be used in an air conditioner that compresses refrigerant. Also, the turbomachine 10 may be applied to a turbocharger that supercharges intake air to an engine of a vehicle.

In the embodiment, the foil bearing unit U1 including the radial foil bearing 20 and the thrust foil bearing 30 is applied to the turbomachine 10, but there is no limitation on the application target of the foil bearing unit U1.

1. A foil bearing, comprising:
a top foil that includes a bearing surface facing a rotary member and extends in a circumferential direction, the top foil including a fixed end at one end in the circumferential direction and a free end at the other end in the circumferential direction; and
a sheet-shaped back foil elastically supporting the top foil, wherein
the top foil includes:
a connecting section that connects, at a location between the fixed end and the free end, a first side of the top foil, at which the bearing surface is located, to a second side of the top foil, at which the back foil is located; and
a cutout section that reduces a thickness of the top foil so as to facilitate deformation of the top foil, and
the cutout section is formed at the second side rather than at the first side.

2. The foil bearing according to claim 1, wherein
the top foil includes:
a first plate member forming the bearing surface, the first plate member including a first fixed end at one end in the circumferential direction and a first free end at the other end in the circumferential direction; and
a second plate member including the cutout section, the second plate member including a second fixed end at one end in the circumferential direction and a second free end at the other end in the circumferential direction, and
the top foil is formed by stack the first plate member and the second plate member together.

3. The foil bearing according to claim 2, wherein
the top foil includes a third plate member covering the cutout section, and
the third plate member includes a third fixed end at one end in the circumferential direction and a third free end at the other end in the circumferential direction.

4. The foil bearing according to claim 1,
wherein the cutout section is one of multiple cutout sections that extend in the circumferential direction and are arranged side by side only in an axial direction of the rotary member.

5. The foil bearing according to claim 1, wherein the cutout section is one of multiple cutout sections that extend in the circumferential direction and are arranged side by side only in a radial direction of the rotary member.

6. The foil bearing according to claim 1, wherein
the back foil includes a slit, and
the top foil is positioned relative to the back foil such that the cutout section extends along the slit.

7. A foil bearing unit including the foil bearing according to claim 1, the foil bearing unit comprising:
a housing that supports the rotary member through the foil bearing; and
a motor chamber formed in the housing, the motor chamber being configured to house an electric motor including a rotor that rotates synchronously with the rotary member and a stator around which a coil is wound,
wherein the motor chamber is configured such that a coolant for cooling the foil bearing is conducted into the motor chamber.

8. The foil bearing according to claim 1, wherein
the top foil includes a plate member covering the cutout section, and
the plate member includes a fixed end at one end in the circumferential direction and a free end at the other end in the circumferential direction.
